(19) United States
(12) Patent Application Publication
(10) Pub. No.: US 2007/0193935 A1
(43) Pub. Date: Aug. 23, 2007

(54) SYSTEM AND METHOD FOR PROVIDING CONTINUOUS, IN-SITU, ANTIWEAR CHEMISTRY TO ENGINE OIL USING A FILTER SYSTEM

(75) Inventors: Ronald L. Elsenbaumer, Arlington, TX (US); Pranesh B. Aswath, Grapevine, TX (US); Harold Shaub, Coppell, TX (US); David P. Owen, Dallas, TX (US)

Correspondence Address: FULBRIGHT & JAWORSKI L.L.P, 2200 ROSS AVENUE, SUITE 2800, DALLAS, TX, 75201-2784, US

(73) Assignees: Platinum Research Organization, L.P., Dallas, TX (US); Board of Regents University of Texas System, Austin, TX (US)

(21) Appl. No.: 11/622,680

(22) Filed: Jan. 12, 2007

Related U.S. Application Data
(60) Provisional application No. 60/758,704, filed on Jan. 13, 2006.

(51) Int. Cl. B01D 29/00

(52) U.S. Cl. 210/209

(57) ABSTRACT

A additive is incorporated into a filter for use with engine oil such that when the engine oil passes through the filter media the engine oil, or components of the engine oil react with the additive inside the filter to produce compounds that increase the anti-wear and/or lubricating properties of the engine oil. The filter additive may be formed by an organic or metal fluoride material.

### CROSS-REFERENCE TO RELATED APPLICATIONS

This application claims priority to U.S. Provisional Application No. 60/758,704, filed Jan. 13, 2006, which is incorporated by references herein in its entirety.

### TECHNICAL FIELD

The present application relates generally to lubricant additives and, more particularly, to incorporating additives into a filter such that the additives can react with ingredients in engine oil yielding a product with superior lubricating performance.

### BACKGROUND OF THE INVENTION

Lubricants comprise a variety of compounds selected for desirable characteristics such as anti-wear and anti-friction properties. Often commercial lubricants are compositions containing a lubricant base such as a hydrocarbon oil or grease, to which is added numerous lubricant additives selected for additional desirable properties. Lubricant additives may enhance the lubricity of the lubricant base and/or may provide anti-wear or other desirable characteristics.

Lubricant bases used in conventional lubricants usually have lubricant additives added to them to improve anti-wear properties and lubricity. Unfortunately, many of these lubricant additives must be added by the lubricant manufacturer and do not provide sufficient additional anti-wear properties or lubricity and/or possess additional undesirable characteristics. It would, therefore, be beneficial to have a system which improved on the characteristics of current lubricants and lubricant/additives which could be introduced into the lubricant by a route other than an lubricant manufacturer, such as, for example, by a filter manufacturer.

Accordingly, it is an object of the present invention to provide an oil filter system which incorporates environmentally-friendly anti-wear additives as part of the filter. It is another object of the present invention to contact and/or react ingredients in the lubricant with the additives incorporated in the filter. Thereby resulting in a lubricant having desirable anti-wear and anti-friction characteristics.

### BRIEF SUMMARY OF THE INVENTION

Embodiments of the invention comprise a filter for use in filtering engine oils having lubricant additives, the filter including a filter media through which the engine oil passes; and an additive incorporated into the filter, the filter additive reacting with the lubricant additives in the engine oil to form compounds which enhance the lubricating effects of the engine oil.

Other embodiments of the present invention describe a method for increasing the lubricating properties of engine oil by embedding an additive into a filter media in the filter, the filter media used filter the engine oil; and causing the engine oil to come into contact with the additive thereby reacting components of the engine oil with the additive to form compounds that increase the lubrication properties of the engine oil.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a table of possible organophosphate formulas used with certain embodiments of the present invention;

FIGS. 2A-D show various organophosphate structures used with certain embodiments of the present invention;

FIG. 3 shows PTFE structures used with certain embodiments of the present invention;

FIGS. 4A and 4B show reaction products of certain embodiments of the present invention;

FIG. 5 shows the results of differential scanning calorimetry (DSC) tests to determine the decomposition temperatures of ZDDP;

FIG. 6 shows wear volume test results for engine oils from a ball on cylinder test;

FIG. 7 is a cut-away view of an embodiment of an engine oil filter which can incorporate filter media embedded with a lubricant additive in accordance with the present invention;

FIGS. 8A-F are NMR spectra of the charting compounds and reaction products between the ZDDP and FeF3; and

FIG. 9 shows the compounds formed on the reaction between ZDDP and Thiophosphate, organophosphates, and their salts with FeF3.

### DETAILED DESCRIPTION OF THE INVENTION

Oil filters are used to filter out solid particles and sludge accumulation in engine oil. These filters are made up of cellulose filter media, synthetic media or extremely fine metallic mesh. In all cases the oil filter removes particles larger than 8-10 μm in size from the circulating oil. In addition all the oil in the crankcase is circulated through the filter every minute of operation of the engine. This affords the possibility of introducing new chemistry into the filter that can react with ingredients in engine oil, either in-situ or by releasing additive into the oil, to produce enhanced protection of the engine. The new chemistry can be added to the filter by incorporating it in the filter media, in a filter port such as the inlet or outlet, or the filter housing or any other place in the filter that could bring the chemistry into contact with the lubricant.

Embodiments of the present invention provide improved filters, such as automotive engine filters, in which high performance lubricant additives are incorporated. The additives when reacted and/or brought into contact with lubricants and additives or components in those lubricants provide enhanced wear protection, lower coefficients of friction, and low cohesive energy surfaces. Filters provided with lubricant additives according to embodiments of the present invention may be used with any lubricant systems that traditionally employ filter systems crankcase oils and other engine oils. Embodiments of the lubricant additives used in the present invention generally react together organophosphate compounds with or without metal halide and/or organofluoride compounds, to produce lubricant additives.

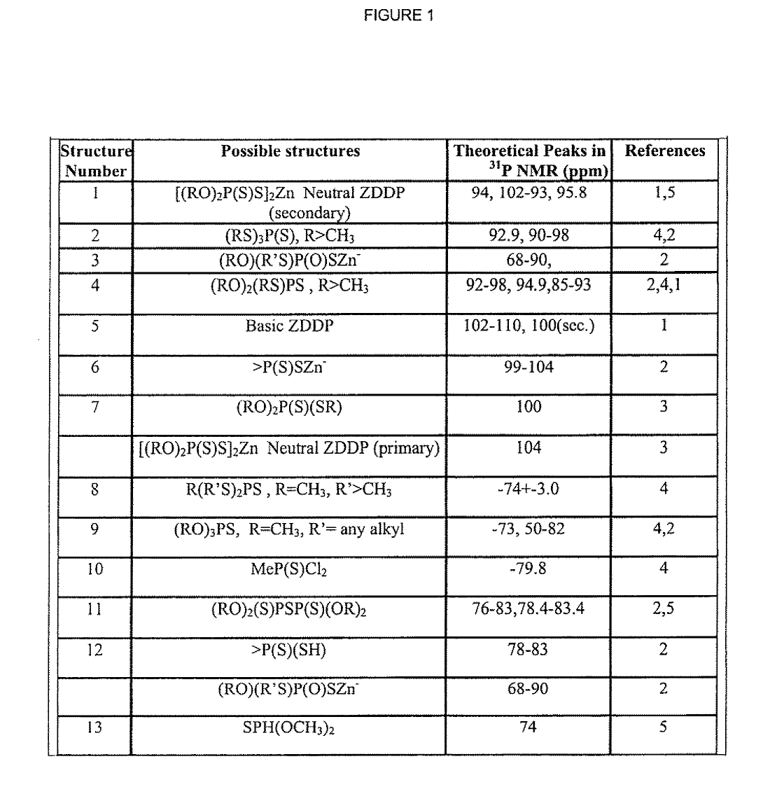

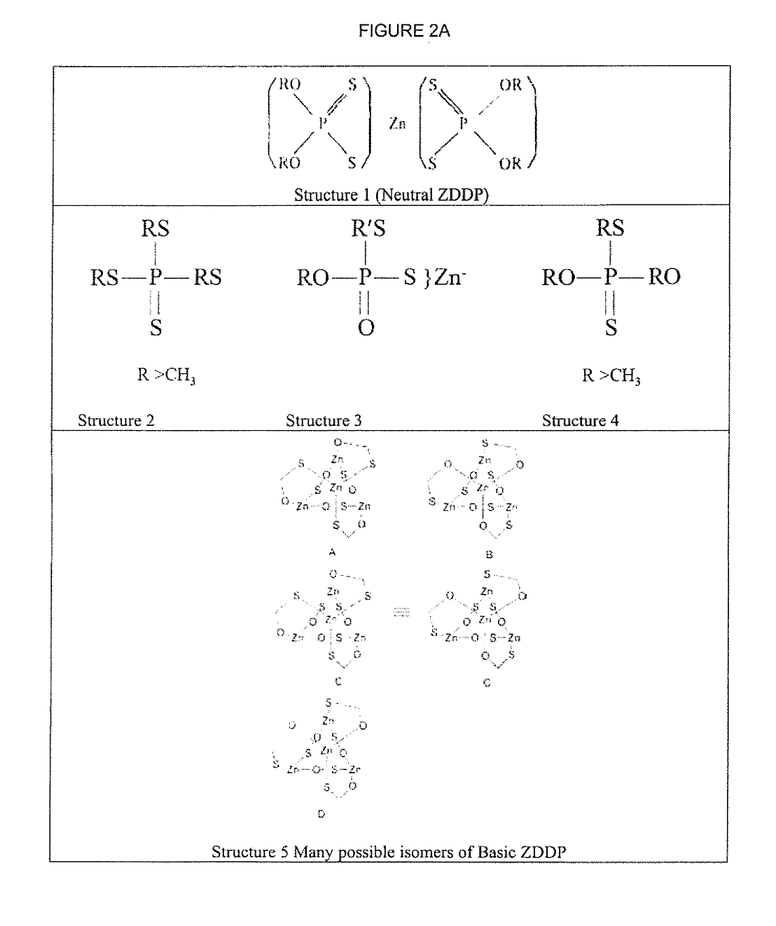

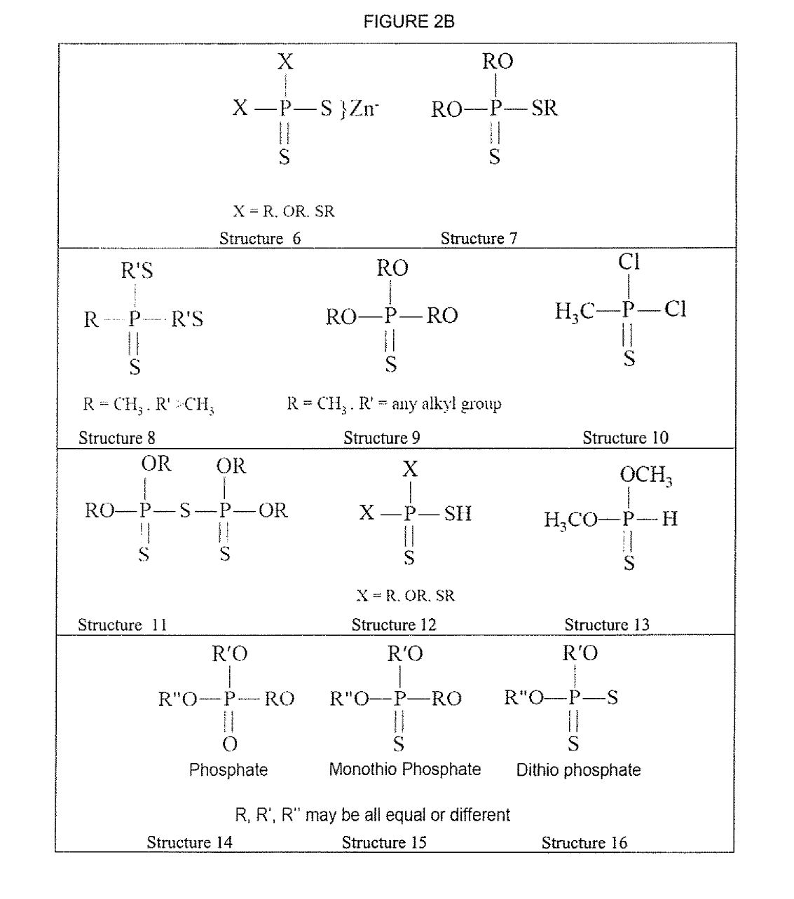

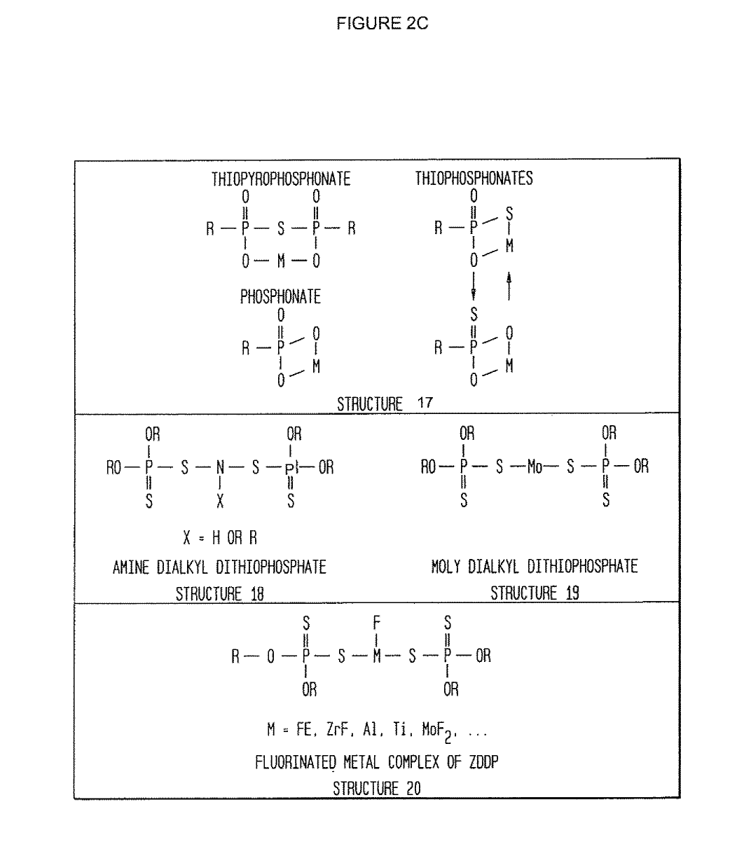

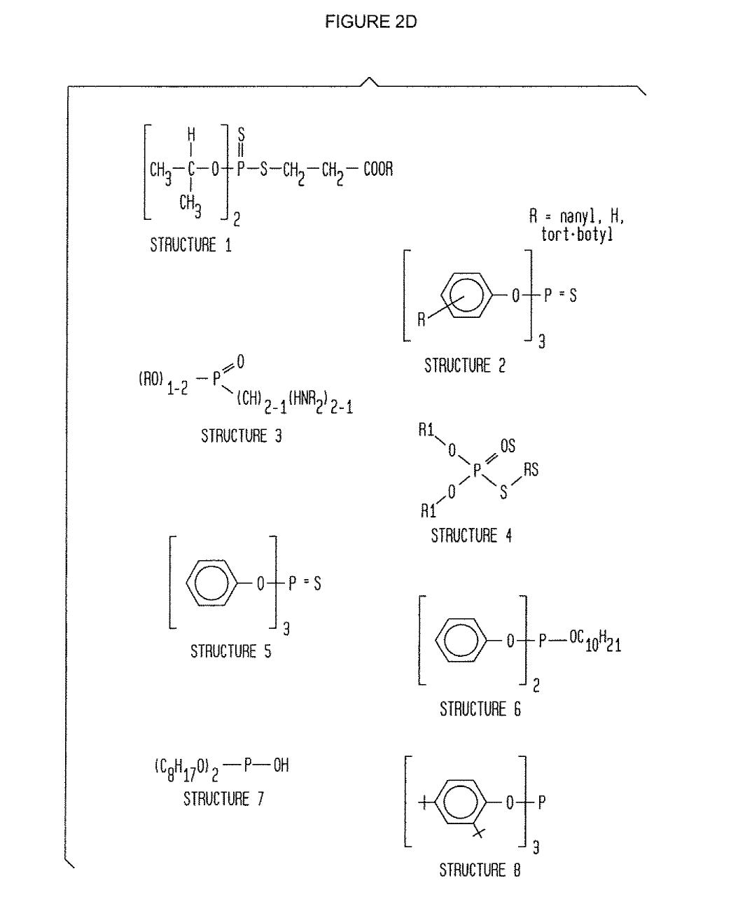

FIG. 1 is a table showing several of the organophosphate compounds that may be used in reactions with embodiments of the present invention as components of the lubricant, such as engine oil, the embodiments of the present invention including metal or organic fluorides incorporated into the filter which then are brought into contact with the engine oil components. Generally, dithiophosphates and ammonium and amine salts of monothiophosphates and dithiophosphates can be present. Metal organophosphates and organothiophosphates such as zinc dialkyldithiophosphate (ZDDP) are encompassed by the term “organophosphate” for the purposes of this disclosure. Other organophosphates listed in FIG. 1 include neutral ZDDP (primary), neutral ZDDP (secondary), basic ZDDP, (RS)₃P(s) where R>CH₃, (RO)(R′S)P(O)SZn₋, (RO)₂(RS)PS where R>CH₃, P(S)(S)Zn₋, (RO)₂P(S)(SR), R(R′S)₂PS where R=CH₃ and R′>CH₃, (RO)₃PS where R=CH₃ and R′=alkyl, MeP(S)Cl₂, (RO)₂(S)PSP(S)(OR)₂, P(S)(SH), (RO)(R′S)P(O)SZn⁻, SPH(OCH₃)₂, where R=any alkyl and R′=any alkyl, and combinations thereof. The chemical structures of representative compounds from FIG. 1 and additional organophosphate compounds that may be used with the invention are shown in FIGS. 2A-2C. In certain embodiments of the present invention, organophosphates not shown in FIGS. 1 and 2A-2C may be used.

The organophosphate ZDDP is generally found in the lubricant used in the filtered systems contemplated by the present invention . ZDDP, alone or in combination with other organophosphates, can occur in one or more moieties. Preferably, the ZDDP used is the neutral or basic moiety. Some of the ZDDP moieties are shown in FIG. 2A as structures 1 and 5. In a preferred embodiment, the ZDDP alkyl groups total approximately 1-20 carbon atoms. The alkyl groups of the ZDDP can assume various forms known to those of skill in the art such as branched- or straight-chain primary, secondary, or tertiary alkyl groups.

Additional organophosphate structures that may be usable with embodiments of the present invention are shown in FIG. 2D. The organophosphate structures specifically disclosed herein are representative structures and are in no way intended to limit embodiments of the present invention to those structures. Many embodiments of the present invention utilize organophosphate compounds not specifically shown.

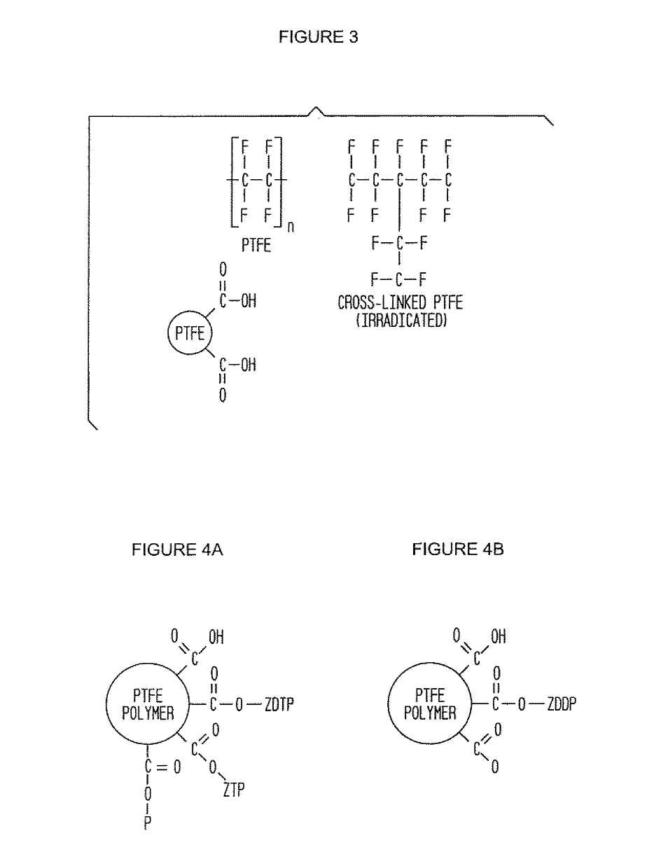

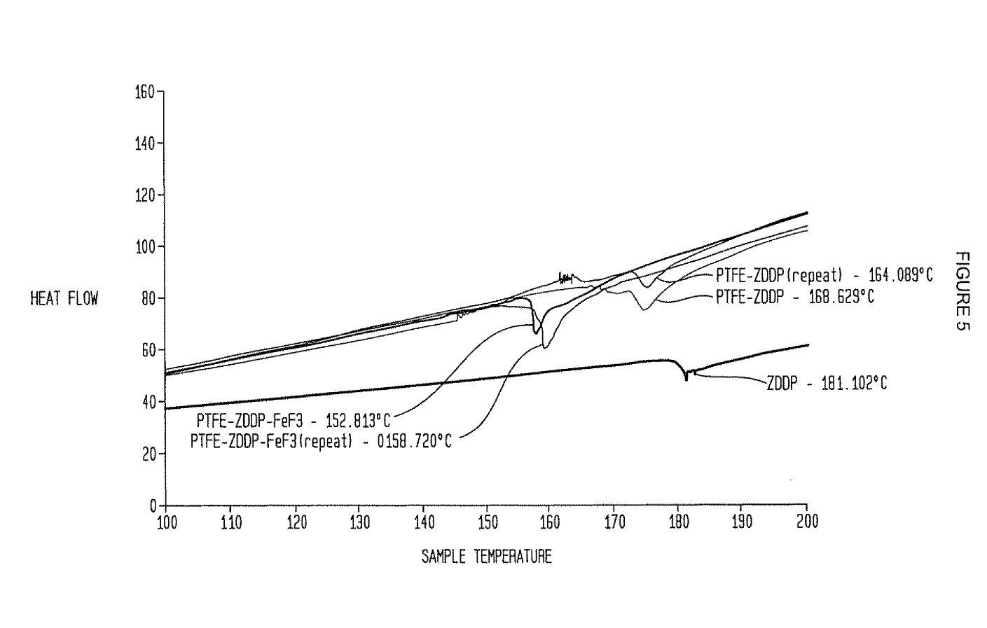

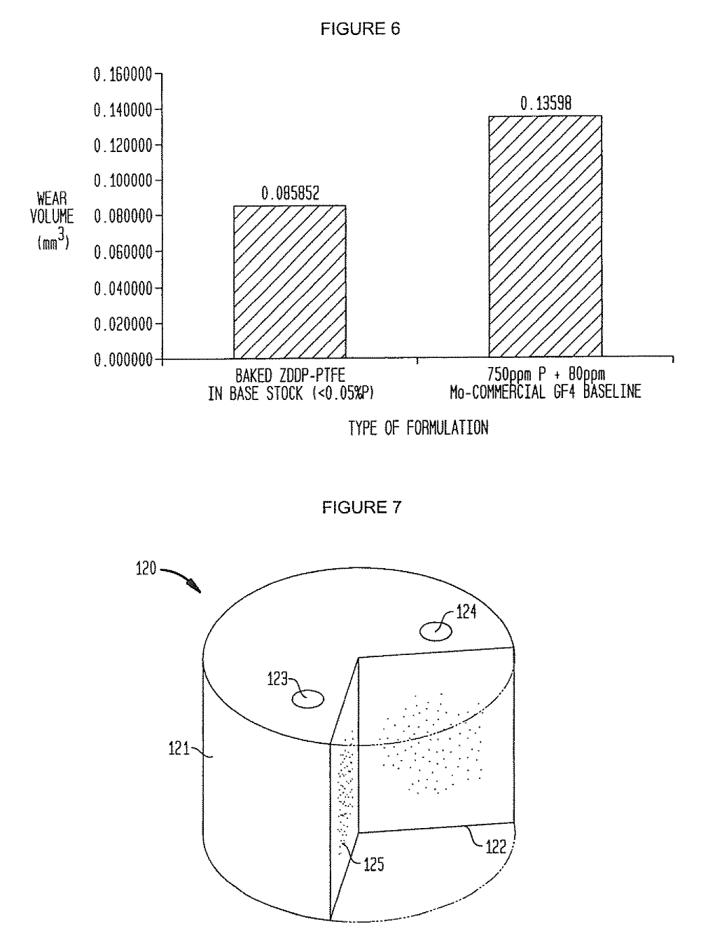

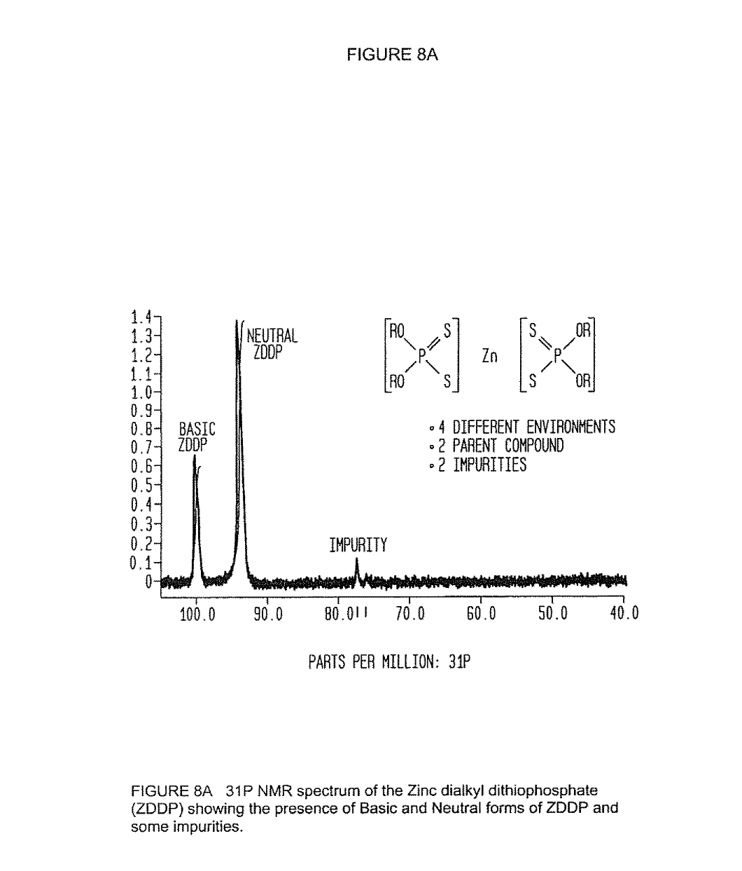

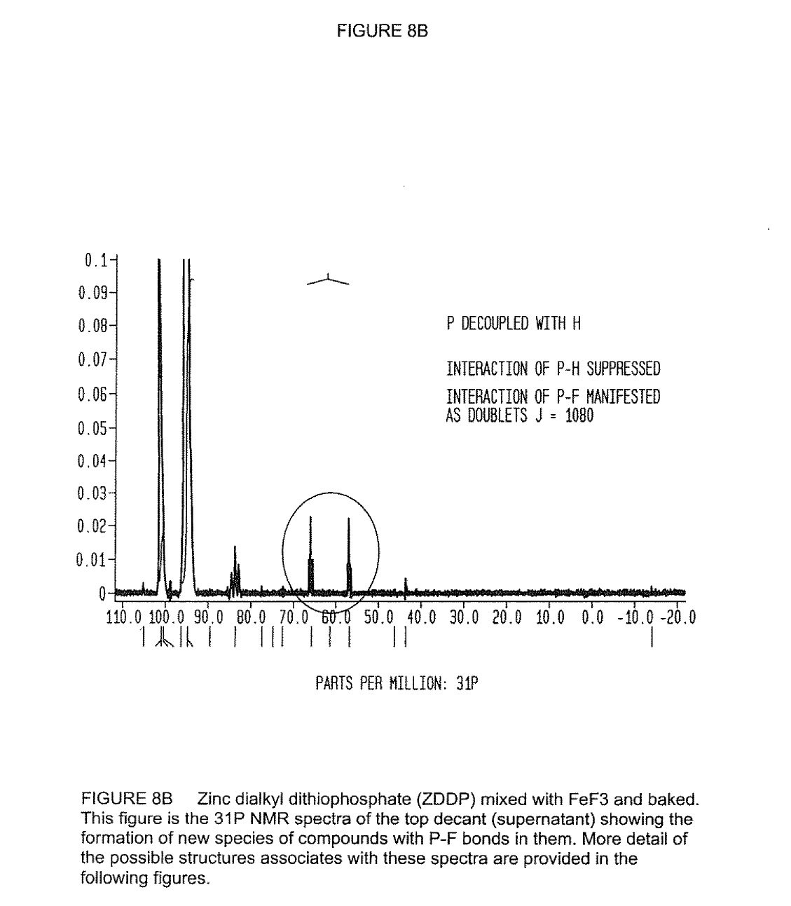

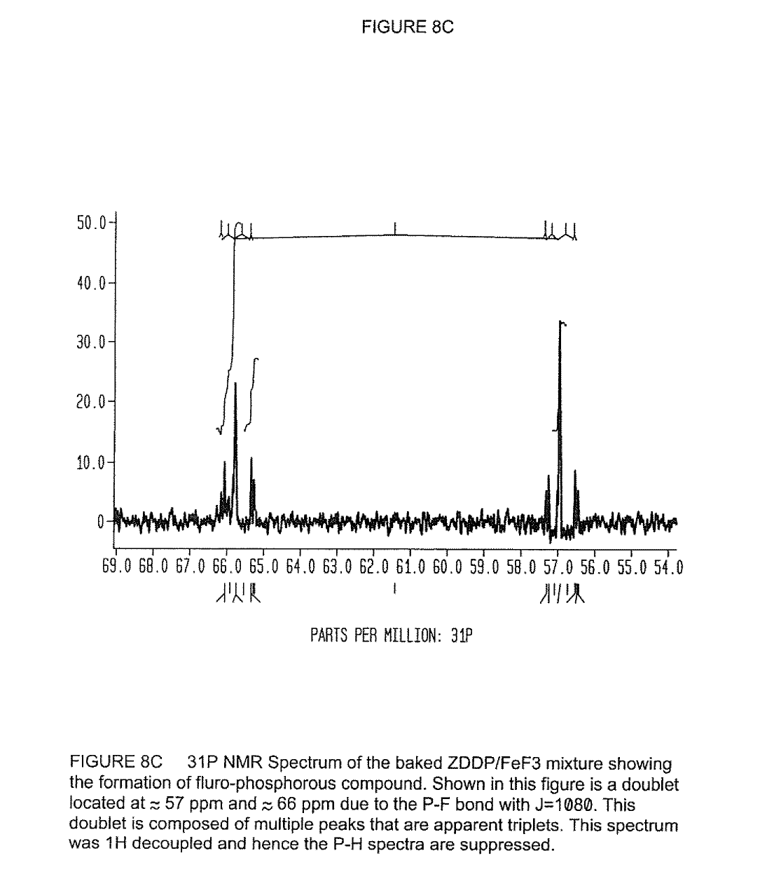

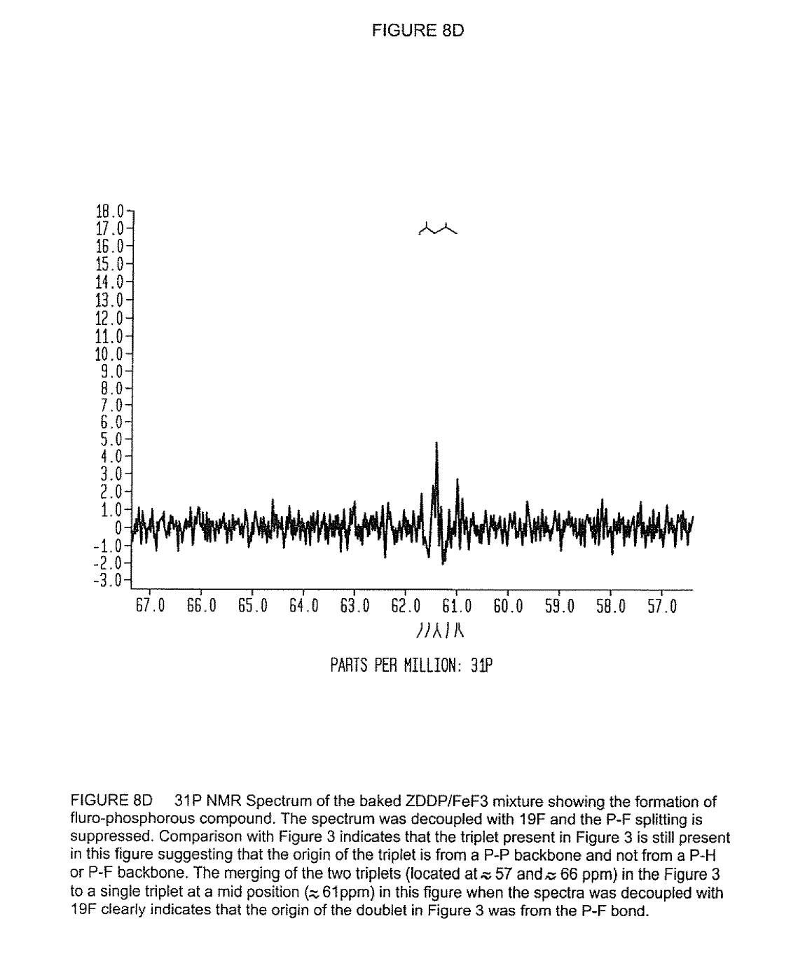

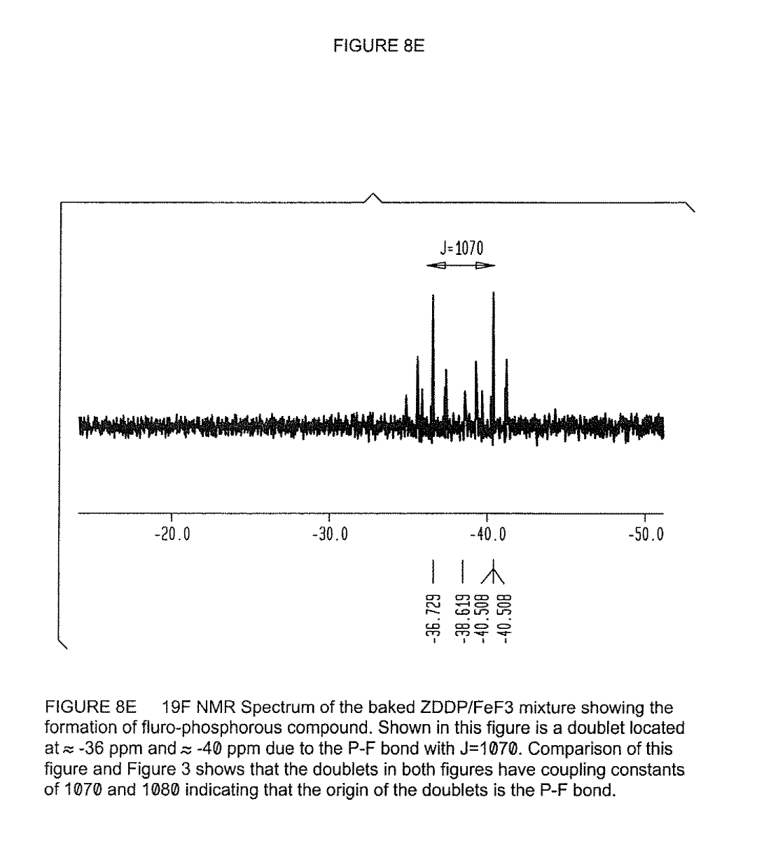

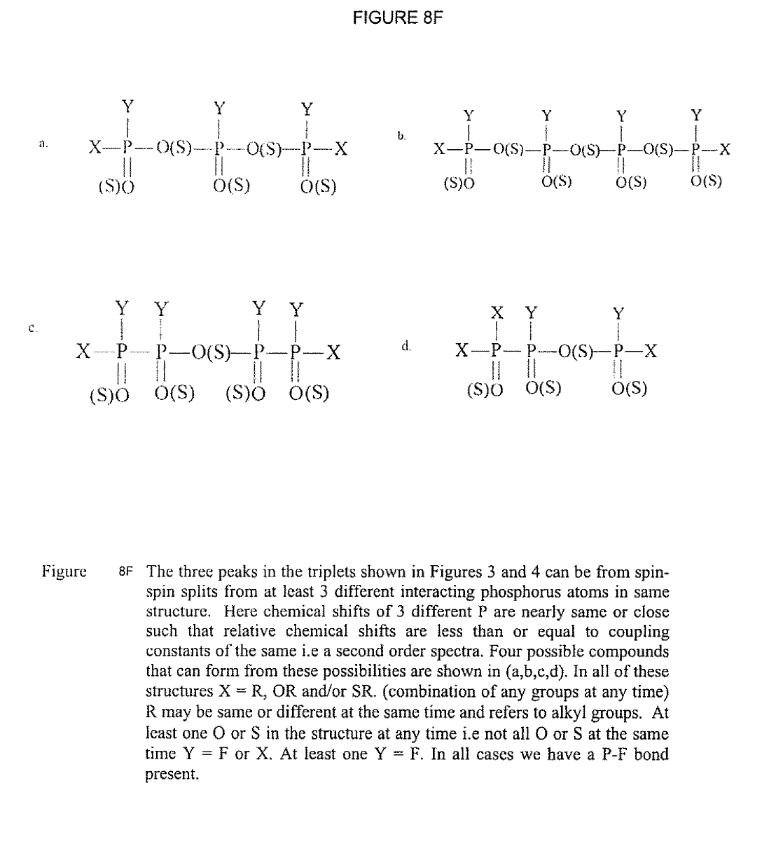

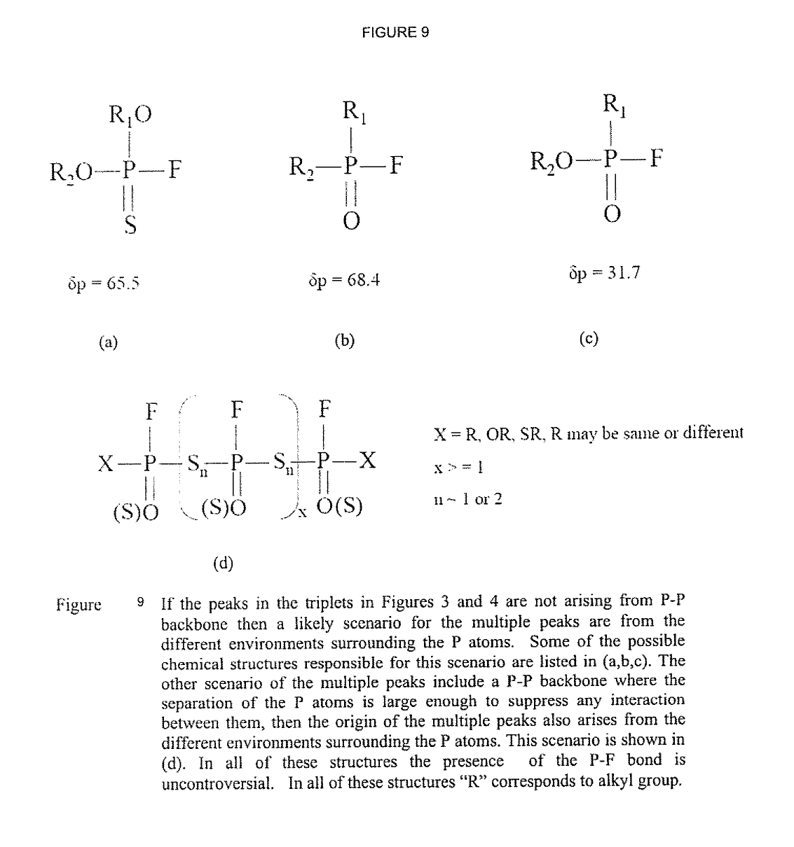

A variety of organofluorine compounds are usable with the present invention. Polytetrafluoroethylene (PTFE) and its derivatives are particularly suited for use with embodiments of the present invention as are other organic or metal fluorides. PTFE structures are shown in FIG. 3. Other organofluorine compounds that are usable include, but are not limited to, fluoroalkyl carboxylic acids, fluoroaryl carboxylic acids, fluoroalkylaryl carboxylic acids, and the like; compositions comprising fluoroalkyl sulfonic acids, fluoroaryl sulfonic acids, or fluoroalkylaryl sulfonic acids, and the like, and their derivatives, such as alkyl and fluoroalkyl esters and alkyl, or fluoroalkyl alcohols and alkyl, or flouroalkyl amides. Particularly preferred compositions are those described above that have more than one functional group, such compositions including any combination of two or more functional groups including carboxylic acids, sulfonic acids, esters, alcohols, amines and amides, and mixtures thereof. Organofluorine compounds can be partially fluorinated or per fluorinated. Certain of these organofluorine compounds can catalyze the decomposition of organophosphate materials with which they are mixed at a lower temperature than without these materials present. Likewise, these compositions can react with metal fluorides, such as FeF₃ and TiF₃, ZrF₄, AlF₃ and the like. In general, organofluorine materials can be of high, low or moderate molecular weight. FIG. 1B shows exemplary molecular structures of PTFE.

Also used in preferred embodiments is an electron-beam irradiated PTFE. Irradiated PTFE comprises additional active end groups formed by carrying out the irradiation process in an air environment. During the process, the long-chain PTFE molecules are cleaved to form shorter-chain molecules with polar end-groups such as carboxyl groups. Charged PTFE molecules with carboxyl groups present can be attracted to metal surfaces, as explained in SAE Publication No. 952475 entitled “Mechanism Studies with Special Boundary Lubricant Chemistry” by Shaub et al., and SAE Publication No. 941983 entitled “Engine Durability, Emissions and Fuel Economy Studies with Special Boundary Lubricant Chemistry” by Shaub et al., the contents of which are herein incorporated by reference. Irradiated PTFE combined with an organophosphate such as, for example, ZDDP, can enhance the rate of decomposition of ZDDP and form reaction products that are usable as high-performance lubricant additives.

In a preferred embodiment, an intent of a reaction as described above is to produce two products. One is a clear decant liquid which comprises neutral ZDDP, fluorinated ZDDP and/or a PTFE complex that has attached ZDDP, phosphate, and thiophosphate groups. The first product can be used for oils as a low-phosphorous, high performance additive and in greases as a high performance additive. The second product comprising settled or centrifuged solid products comprises predominantly PTFE and PTFE complexes with ZDDP, phosphates and thiophosphates, and can be used as a grease additive. Both of the reaction products are believed to have affinity for metal surfaces. When used (or formed, as described further below) in a lubricating composition, the reaction products bind to, or concentrate on, the metal surface, providing wear and friction protection. FIGS. 4A and 4B show PTFE/ZDDP complexes that are possible reaction products that may form in certain embodiments of the present invention. However, these are only an exemplary product and additional structures may be formed in these or other embodiments of the present invention. Although ZDDP and PTFE are a focus of the discussion above, other organophosphates and organofluorine compounds are expected to produce similar reaction products usable as high-performance additives,

In certain embodiments, one or more compounds with reactivity can be incorporated into the filter, such as be embedding the additive in the filter media or bonding it to other parts of the filter, so as to accelerate or effect a reaction, when added to a reaction of ZDDP and a metal fluoride or PTFE. These reactive agents can speed up the reaction with ZDDP, PTFE/metal fluoride, or both, or other materials with these compositions inside the filter, to give new lubricant additives. Metal halides such as ferric fluoride are reactive materials used in preferred embodiments of the present invention. Metal halides used with certain embodiments of the present invention may be, for example, aluminum trifluoride, zirconium tetrafluoride, titanium trifluoride, titanium tetrafluoride, and combinations thereof. In other embodiments, other transition metal halides are used, such as, for example, chromium difluoride and trifluoride, manganese difluoride and trifluoride, nickel difluoride, stannous difluoride and tetrafluoride, and combinations thereof. Ferric fluoride may be produced according to a process described in co-pending U.S. patent application Ser. No. 110/662,992 filed Sep. 15, 2003, the contents of which are herein incorporated by reference. In embodiments that react metal halides with ZDDP and PTFE, resulting reaction mixtures may comprise both solid and liquid phase components. Liquid phase product comprising fluorinated ZDDP and PTFE complexes with attached ZDDP, phosphate, and thiophosphate groups can be used for both oils and greases as a low-phosphorous and high-performance additive respectively. Solid phase products include flurophosphate, polyphosphate, sulfide compounds among others deposit on the surface of the engine providing additional lubrication and reduced wear. Additional compounds may result from such reactions that may have minor lubricating characteristics.

Irradiated PTFE is particularly suited for use with reaction mixtures comprising organophosphates and metal halides, as it interacts strongly with such compounds resulting in reaction products usable as high performance lubricant additives. Medium to high molecular weight perfluoro alkyl carboxylic acids, or substantially fluorinated alkyl, aryl, or alkylaryl carboxylic acids are also particularly suited for use with embodiments of the present invention. Organofluorine compounds such as fluoroalkyl, fluoroalkylaryl, fluoroaryl, and fluoroarylalkyl alcohols and amines of all molecular weights are also usable with embodiments of the present invention. Particularly preferred compositions are those described above that have more than one functional group, such as compositions comprising any combination of two or more functional groups comprising carboxylic acids, sulfonic acids, esters, alcohols, amines and amides and mixtures thereof. In certain embodiments of the present invention, organofluorine compounds used are soluble in neutral oils at room temperature.

In a preferred embodiment of the present invention, a lubricant additive or additives incorporated into engine oil filters as described herein are intended to be used in the filters of engines using a fully formulated engine oil. The term “fully formulated oil” as used here to illustrate certain embodiments of the present invention are engine oils that include additives, but not ZDDP. In certain embodiments, the frilly formulated oil may be, for example, a GF4 oil with an additive package comprising standard additives, such as dispersants, detergents, and anti-oxidants, but without ZDDP.

Below are presented the results from a series of experiments that were performed to determine the properties of lubricants and lubricant additives produced according to embodiments of the present invention.

FIG. 5 shows the results of differential scanning calorimetry (DSC) tests to determine the decomposition temperatures of ZDDP. The DSC tests were performed at −30° C. to 250° C. at a ramp rate of 1° C./minute under nitrogen. The samples were heated in hermetically-sealed aluminum pans. ZDDP alone decomposes at approximately 181° C. In the presence of PTFE (irradiated, Nanoflon™ powder), ZDDP decomposes at approximately 166° C., and decomposes at 155° C. in the presence of PTFE and ferric fluoride catalyst. ZDDP and PTFE were mixed in a 1:1 ratio, and ZDDP/PTFE/ferric fluoride were mixed in a 2:2:1 ratio. The DSC results indicate that in the presence of PTFE the decomposition temperature of ZDDP is reduced by approximately 15° C. In the presence of both PTFE and ferric fluoride, the decomposition temperature is reduced by approximately 26° C.

Ball on Cylinder Test

FIG. 6 shows wear volume test results for engine oils. The test used is a ball on cylinder test that evaluates the wear-preventing properties of lubricants. A steel cylinder (67 HRC) is rotated at 700 rpm against a tungsten carbide (78 HRC) ball which is loaded with a lever arm to apply a 30 kg load. 50 μL of the test lubricant is uniformly applied through the outer surface of the cylinder at the point of contact with the ball. Wear track depth and wear volume is calculated at the conclusion of the test. The lubricant compositions were prepared as follows. ZDDP and PTFE in a 1:1 ratio were baked in air at 150° C. for 20 minutes and then centrifuged to remove all solids. A measured quantity of the supernatant liquid was added to Chevron 100N base oil to yield less than 0.05 weight percent phosphorous for the lubricant composition. The graph shows that the wear volume for this composition was 0.859 mm³ compared to the wear volume of 0.136 mm³ for a fully formulated commercial GF4 oil comprising 750 ppm phosphorous and 80 ppm molybdenum compound. The results indicate that the synergistic effects of a ZDDP/PTFE composition are effective in formulations intended for engine usage.

Incorporation of Lubricant Additive into Filter Media

We have shown that many of the potential anti-wear agents in engine oils shown in FIG. 1 when reacted with a suitable metal fluoride (most of the transition metal fluoride and some alkali and alkaline earth fluoride) can result in compounds that offer superior antiwear performance compared to Zinc Dialkyl Dithiophosphate (ZDDP). NMR spectra of the starting compounds and reaction products between the ZDDP and FeF3 are shown in FIGS. 8a-8f. Details of the compounds formed on the reaction between ZDDP and thiophosphate compounds with FeF3 are provided in FIG. 9. Reactions involved in the production of these new fluorinated phosphate and thiophosphate compounds are detailed in U.S. patent application Ser. No. 11/221,400, which is hereby incorporated by reference in its entirety.

The products formed by the reaction between ZDDP and other phosphate and thiophosphate compounds and FeF3 or other metal fluoride compounds can be conducted ex-vivo in a laboratory and then used as an additive in engine oil or can be generated in vivo in an engine oil filter or other location in the lubrication system of an engine. The latter approach in which the metal fluoride is incorporated into a filter is attractive alternative to pre-reacting ZDDP prior to addition to engine oil.

An example of an embodiment of an engine oil filter 120 which could be used with the concepts described herein is shown in FIG. 7. Filter 120 includes housing 121 which encapsulates filter media 122. Opening 123 allows the lubricant material being filtered to pass into filter l20, where it then passes through filter media 122 before exiting through opening 124. Additive 125 is incorporated into filter 120, such by embedding the additive in filter media 122 (shown), or bonding the additive to the filter housing 121 or openings 123 or 124 (not shown). Additive 125 is incorporated into filter 120 such that the lubricant is brought into contact with additive 125 as it passes through filter 120.

Oil filter can utilize different types of filter material. These are the materials that capture organic or inorganic contaminants as oil flows through. Organic contaminants include bacteria and other organisms that form gross sludge. Inorganic contaminants consist of dust that's ingested into the engine; along with trace amounts of wear metals from bearings and other internal parts. Today, most low-cost disposable spin-on oil filters use cellulose filter media. Better quality oil filters use synthetic media (usually organic polymers), while top end oil filter use extremely fine metal mesh.

Examples of methods that can be used to incorporate either Fluorine or Metal Fluoride on to the surface of the fibers used in oil filters can include, but are not limited to, the following:

(i) Fluorination of Cellulose Fibers by Gas Plasma: Cellulose fibers made up of cellulose acetate are a common material used in filter media. These fibers are weakly hydrophilic in nature. When these fibers are exposed to plasma of CF4 the surface layer of these cellulose fibers becomes hydrophobic by the incorporation of Fluorine in the surface structure. This Fluorine can subsequently be released on reaction with ZDDP and other phosphate and thiophosphate compounds in engine oil yielding products detailed in FIG. 9.

(ii) Fluorination of Cellulose Fibers by Pulsed Plasma Process: Pulsed plasma process can be used to deposit short chain films of fluorinated films such as polyvinylidene difluoride (PVDF) and poly tetrafluoroethylene (PTFE)2. This approach uses a plasma reactor coupled with a Radio Frequency (RF) generator where the plasma power and duration can be controlled. The fluorination and chain length and film thickness can be controlled. The cellulose fibers can be coated with varying thickness and chain lengths of fluorinated hydrocarbons that can be functionalized to react with ZDDP and other phosphate and thiophosphate compounds.

(iii) Fluorination of Organic Fibers by Electrochemical Fluorination: Electrochemical methods are often used to incorporate Fluorine into organic materials. This process involves the conversion of the C—H to the C—F bond3. Possible approaches used in this process include:

a. Electrochemical fluorination of organic compounds in liquid HF at nickel electrodes by the process developed by J. H. Simmons and coworkers and is known as the Simmons Electrochemical Fluorination process.

b. In a KF.2HF melt on carbon electrodes low molecular weight organic compounds can be fluorinated.

In these approaches the C—H bonds are changed to C—F bond and fluorine is incorporated into the outer layers of the structure. Several possible fluorine sources can be used including tetraethylammoniumfluroborate (Et4NBF4), Et3N with Pyridine-HF can also be used as a source, and Et3N—HF and Et4NF.3HF are also possible sources.

(iv) Direct Fluorination of Metals used in Porous Metal Filters: High performance and longer durability oil filters employ metallic meshes for filtration purposes. These metallic filters can be fluorinated at the near surface region over dimensions ranging from a few nanometers to several microns. There are several methods by which metals can be fluorinated. Reviewed below are a couple of these methods.

a. Metals can be fluorinated on exposure to fluorine gas. Most metallic materials can be fluorinated in this fashion resulting in coatings of metal fluoride on the surface.

b. An electrochemical approach can also be used to fluorinate a metal surface. In this approach a working electrode made up of metal to be fluorinated is used and a counter electrode is made of a compound that is a source of F ions such as PbF2. The working electrode is anodically polarized releasing F ions, which then react with the cation released from the anode resulting in deposits of metal fluoride coatings on the working electrode. This approach can be used to develop fluoride coatings on metals such as Ni, Mo, W, Cr etc.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A filter for use in filtering engine oils having lubricant additives, the filter comprising:
a filter media through which the engine oil passes; and
an additive incorporated in the filters the filter additive reacting with the lubricant additives in the engine oil to form compounds which enhance the lubricating effects of the engine oil.

2. The filter of claim 1 wherein the filter additive is a metal fluoride compound.

3. The filter of claim 1 wherein the lubricant additive is ZDDP.

4. The filter of claim 1 wherein the filter additive is incorporated in the filter port.

5. The filter of claim 1 wherein the filter additive is incorporated in the filter housing

6. The filter of claim 1 wherein the filter additive is embedded in the filter media.

7. The filter of claim 5 wherein the filter media is comprised of organic fibers and the filter additive is added to the filter media by gas plasma.

8. The filter of claim 5 wherein the filter media is comprised of organic fibers and the filter additive is added to the filter media by a pulsed plasma process.

9. The filter of claim 5 wherein the filter media is comprised of organic fibers and the filter additive is added to the filter media by an electrochemical process.

10. The filter of claim 9 wherein the filter media is porous metal and the filter additive is added to the filter media by exposure to a gas including the filter additive.

11. The filter of claim 9 wherein the filter media is porous metal and the filter additive is added to the filter media by an electrochemical process.

12. A method for increasing the lubricating properties of engine oil comprising:
incorporating an additive into the filter, the filter used filter the engine oil; and
causing the engine oil to come into contact with the additive thereby reacting components of the engine oil with the additive to form compounds that increase the lubrication properties of the engine oil.

13. The method of claim 12 wherein the additive is a metal fluoride compound.

14. The method of claim 12 wherein the components of the engine oil include ZDDP.

15. The method of claim 12 wherein the additive is incorporated into a filter media in the filter.

16. The method of claim 15 wherein the filter media is comprised of organic fibers.

17. The method of claim 16 wherein the incorporating occurs by a gas plasma process.

18. The method of claim 16 wherein the incorporating occurs by a pulsed plasma process.

19. The method of claim 16 wherein the incorporating occurs by an electrochemical process.

20. The method of claim 15 wherein the filter media is porous metal.

21. The method of claim 20 wherein the incorporating occurs by exposure to a gas including the additive.

22. The method of claim 20 wherein the incorporating occurs by an electrochemical process.

23. The method of claim 12 wherein the additive is incorporated into the filter housing.

24. The method of claim 12 wherein the additive is incorporated into a filter port
